(19) United States
(12) Patent Application Publication
(10) Pub. No.: US 2025/0178645 A1
(43) Pub. Date: Jun. 5, 2025

(54) TECHNIQUES FOR DISTRIBUTING REMOTE CONNECTED VEHICLE OPERATION REQUESTS

(71) Applicant: Ottopia Technologies Ltd., Tel Aviv (IL)

(72) Inventors: Alexander KIRSHON, Netanya (IL); Zvi KLEINER, Herzliya (IL)

(73) Assignee: Ottopia Technologies Ltd., Tel Aviv (IL)

(21) Appl. No.: 18/529,643

(22) Filed: Dec. 5, 2023

(51) Int. Cl. B60W 60/00; G05B 13/02

(52) U.S. Cl. CPC B60W 60/005; G05B 13/0265; B60W 2556/45

(57) ABSTRACT

A system and method for contextual distribution of remote connected vehicle operation requests. A method includes: classifying a plurality of requests for remote connected vehicle operation into a plurality of classifications, wherein each request corresponds to a respective connected vehicle of a plurality of connected vehicles; determining a distribution for the plurality of requests based on the plurality of classifications, wherein at least a portion of the plurality of requests is assigned to respective operators of a plurality of operators based on capabilities associated with each of the plurality of operators; and transmitting the plurality of requests based on the distribution.

### TECHNICAL FIELD

The present disclosure relates generally to managing remote connected vehicle operation requests, and more specifically to distributing remote connected vehicle operation requests.

### BACKGROUND

Driving assistance technologies enable remote operators to take over or otherwise assist with driving vehicles from afar. Some driving assistance solutions may allow remote operators to assume control of the vehicle, for example, when an emergency prevents the driver of the vehicle from navigating or otherwise reacting to obstacles in the road. By directing assisted driving requests to operators, potential disasters may be averted.

A challenge with assisted driving is ensuring that requests are handled appropriately. If requests are not handled properly, then assistance may come too late or otherwise fail to prevent accidents.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for contextual distribution of remote connected vehicle operation requests. The method comprises: classifying a plurality of requests for remote connected vehicle operation into a plurality of classifications, wherein each request corresponds to a respective connected vehicle of a plurality of connected vehicles; determining a distribution for the plurality of requests based on the plurality of classifications, wherein at least a portion of the plurality of requests is assigned to respective operators of a plurality of operators based on capabilities associated with each of the plurality of operators; and transmitting the plurality of requests based on the distribution.

Certain embodiments disclosed herein also include a non-transitory computer readable medium having stored thereon causing a processing circuitry to execute a process, the process comprising: classifying a plurality of requests for remote connected vehicle operation into a plurality of classifications, wherein each request corresponds to a respective connected vehicle of a plurality of connected vehicles; determining a distribution for the plurality of requests based on the plurality of classifications, wherein at least a portion of the plurality of requests is assigned to respective operators of a plurality of operators based on capabilities associated with each of the plurality of operators; and transmitting the plurality of requests based on the distribution.

Certain embodiments disclosed herein also include a system for contextual distribution of remote connected vehicle operation requests. The system comprises: a processing circuitry; and a memory, the memory containing instructions that, when executed by the processing circuitry, configure the system to: classify a plurality of requests for remote connected vehicle operation into a plurality of classifications, wherein each request corresponds to a respective connected vehicle of a plurality of connected vehicles; determine a distribution for the plurality of requests based on the plurality of classifications, wherein at least a portion of the plurality of requests is assigned to respective operators of a plurality of operators based on capabilities associated with each of the plurality of operators; and transmit the plurality of requests based on the distribution.

Certain embodiments disclosed herein include the method, non-transitory computer readable medium, or system noted above or below, further including or being configured to perform the following step or steps: creating at least one queue of the plurality of requests based on the plurality of classifications, where the distribution is determined based further on the at least one queue.

Certain embodiments disclosed herein include the method, non-transitory computer readable medium, or system noted above or below, wherein the method is performed by a central system, further including or being configured to perform the following step or steps: translating each of the plurality of requests into a plurality of translated requests based on criteria defined in at least one request distribution policy via an application programming interface disposed between each of the plurality of vehicles and the central system, wherein the distribution is determined based further on the plurality of translated requests.

Certain embodiments disclosed herein include the method, non-transitory computer readable medium, or system noted above or below, further including or being configured to perform the following step or steps: generating at least one parallel flow for the plurality of requests based on at least one parallel flow trigger, wherein the distribution is determined based further on the at least one parallel flow.

Certain embodiments disclosed herein include the method, non-transitory computer readable medium, or system noted above or below, wherein the plurality of requests is transmitted via a first system, wherein at least a portion of the at least one parallel flow is transmitted via a second system.

Certain embodiments disclosed herein include the method, non-transitory computer readable medium, or system noted above or below, wherein at least one first request of the plurality of requests is assigned to at least two operators of the plurality of operators.

Certain embodiments disclosed herein include the method, non-transitory computer readable medium, or system noted above or below, further including or being configured to perform the following step or steps: generating at least one additional instance for each of the at least one first request, wherein the distribution is determined based further on the at least one additional instance generated for each of the at least one first request.

Certain embodiments disclosed herein include the method, non-transitory computer readable medium, or system noted above or below, further including or being configured to perform the following step or steps: classifying a plurality of network connectivity statuses into a plurality of network connectivity status classifications, each network connectivity status being associated with a respective remote operator of the plurality of remote operators, wherein the distribution is determined based further on the plurality of network connectivity status classifications.

Certain embodiments disclosed herein include the method, non-transitory computer readable medium, or system noted above or below, wherein the capabilities associated with the plurality of operators include at least one operating station capability of each of a plurality of operating stations accessible to the plurality of operators.

Certain embodiments disclosed herein include the method, non-transitory computer readable medium, or system noted above or below, wherein at least a portion of the requests is assigned to automated remote vehicle operation systems.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIGS. 1A-B are networks diagram utilized to describe various disclosed embodiments.

FIG. 2 is a flowchart illustrating a method for distributing remote connected vehicle operation requests according to an embodiment.

FIG. 3 is a flowchart illustrating a method for classifying requests according to an embodiment.

FIG. 4 is a schematic diagram of a request distributor according to an embodiment.

### DETAILED DESCRIPTION

The various disclosed embodiments include techniques for distributing remote connected vehicle operation requests. Specifically, various disclosed embodiments allow for distributing remote connected vehicle operation requests to operators for remote assistance or remote driving based on capabilities associated with respective operators (e.g., capabilities of those operators, capabilities of operator stations accessible to those operators, or both), data in the requests, and the like. The capabilities of operators may be defined with respect to permissions, skill or experience levels, particular abilities or skills each operator is trained to perform, legal or regulatory restrictions, combinations thereof, and the like. The capabilities of operator stations may be defined with respect to hardware used for driving assistance by each operator.

In this regard, it is noted that operators which perform remote operation activities or otherwise aid in operation of connected vehicles remotely may have a variety of abilities and/or limitations that render certain operators more capable of successfully navigating a particular situation better than others, such as level of skill, years of experience, authorizations, operating stations the operators have access to, and so on. The disclosed embodiments allow for an automated and context-aware solution which can be utilized to automatically distribute requests to appropriate operators.

To this end, requests for remote operation during connected vehicle operation (“remote connected vehicle operation requests”) are received from connected vehicles, analyzed, and then distributed to potential remote operators based on the analysis. The requests may include requests for remote driving, requests for remote assistance, or both. In some embodiments, requests corresponding to respective vehicles are classified. Based on the classifications of the requests and capabilities related to potential remote operators (e.g., capabilities of the operators themselves or of operating stations accessible to those remote operators), a distribution of the requests is determined.

The distribution includes assignment of at least some of the requests to respective remote operators and may be determined based on factors such as urgency, priority, or other requirements of the request which may be defined in one or more policies. The requests are transmitted based on the distribution such that the requests are sent to appropriate operators or automated systems for servicing the requests given the operation activities being requested in each request and any applicable needs pursuant to providing those operation activities in servicing the request.

To support the distribution of remote connected vehicle operation requests, the disclosed embodiments also include various techniques for intake, queueing, and load balancing of such requests. At least some techniques include classifying triggers based on which systems they are received from. Further, various techniques leverage multiple application programming interfaces (APIs) in order to classify requests on both the connected vehicle side and on the remote operator side, which allows for effectively translating requests generated by connected vehicles into data which may be utilized to prioritize and distribute the requests. To this end, an API disposed between connected vehicles and one or more remote operator devices is utilized to communicate data from the connected vehicle requests into classifications related to request requirements, for example, whether the request indicates a safety system engagement scenario, a speed of the connected vehicle, other safety-related conditions, combinations thereof, and the like.

Some disclosed embodiments also include generating parallel flows for potential emergency requests based on emergency indicators in those requests. In an embodiment, certain requests determined to be high urgency are routed to devices of first responders rather than or in addition to being routed to devices of remote operators in order to minimize the amount of time before first responders arrive at the scene of a potential accident. For example, data indicating safety system engagement scenarios such as a sudden stop or accident may be determined as being high urgency and therefore routed to first responders rather than to remote operators. Otherwise, requests may be placed into a multi-priority queue pending processing such that requests are processed according to time pendency and with respect to different user policies.

Various disclosed embodiments further include techniques for optimizing request distributions for network conditions in order to improve performance related to transmitting and receiving requests. To this end, in some embodiments, vehicles, teleoperator stations, or both, are classified based on network connectivity, and request distribution is determined based further on the network connectivity classifications. More specifically, distributions are determined based on network connectivity such that operational assistance requests requiring more intensive data transmission are distributed to stations with better connectivity. As a non-limiting example, a request which requires the use of 8 different cameras to service is distributed to a remote operator stationed at an operator station having a higher classification network connection than a request which requires the use of 4 different cameras, which is assigned to a remote operator stationed at an operator station having a lower classification network connection.

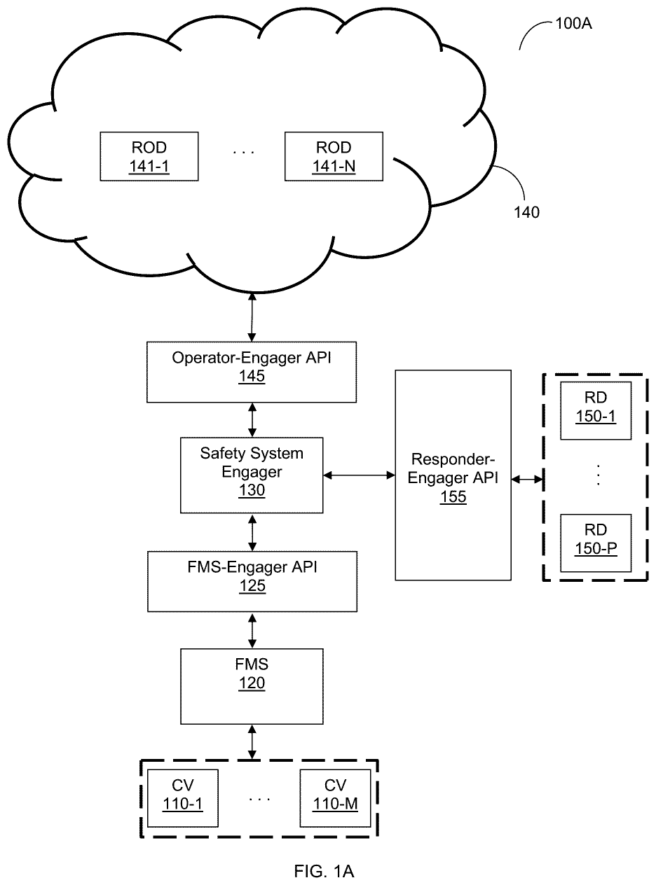

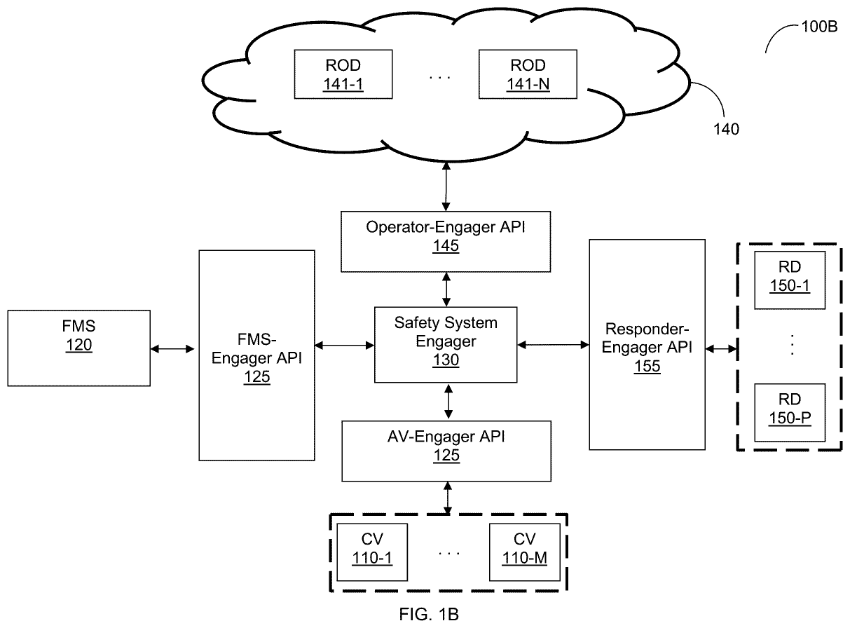

FIGS. 1A-B show example network diagrams 100A and 100B, respectively, utilized to describe the various disclosed embodiments.

The network diagram 100A illustrates a first implementation in which a fleet management system (FMS) 120 is deployed in-line between connected vehicles (CVs) 110-1 through 110-M (where M is an integer greater than 1, hereinafter referred to individually as a connected vehicle 110 and collectively as connected vehicles 110) and a safety system engager 130.

In the network diagram 100A, the safety system engager 130 communicates with the fleet management system 120, remote operator devices (RODs) 141-1 through 141-N (where N is an integer greater than 1, hereinafter referred to individually as a remote operator device 141 and collectively as remote operator devices 141), and responder devices (RDs) 150-1 through 150-P (where P is an integer greater than 1, hereinafter referred to individually as a responder device 150 and collectively as responder devices 150) in order to receive data and distribute requests as described herein.

Each of the connected vehicles 110 is a vehicle configured to communicate with external systems (i.e., one or more systems outside of the connected vehicle). The connected vehicles 110 may be or may include, but are not limited to, autonomous vehicles or other vehicles equipped with remote driving capabilities. Such vehicles equipped with remote driving capabilities are configured to allow for at least partial control by a remote operator (i.e., an operator operating one or more systems for controlling at least a portion of the connected vehicle's functions that are deployed remotely from the connected vehicle).

To support the remote driving capabilities of the connected vehicles 110, the connected vehicles 110 are further configured to send requests for remote driving assistance. Such remote connected vehicle operation requests may include, but are not limited to, requests for indirect remote assistance, requests for direct remote driving, combinations thereof, and the like. Indirect remote assistance requests may include requests for indirectly assisting with driving or operation of the vehicle such as, but not limited to, selecting a path, providing navigation instructions, drawing a navigation path, inputting a destination into a global positioning system (GPS) of the connected vehicle, combinations thereof, and the like. Direct remote driving requests may include, but are not limited to, requests for directly controlling some or all of vehicle operations related to driving such as steering, acceleration, braking, combinations thereof, and the like.

In various embodiments, some or all of the connected vehicles 110 may be arranged in one or more fleets, where each fleet is a grouping of connected vehicles the connected vehicles 110. In such embodiments, the fleet management system 120 is configured to manage one or more of such fleets. To this end, the fleet management system 120 may be configured to send commands to the connected vehicles 110, to send or receive messages to or from the connected vehicles 110, to collect data about communications with or between the connected vehicles 110, combinations thereof, and the like. In other embodiments (not shown), the safety system engager 130 may communicate directly with the connected vehicles 110 rather than via a fleet management system.

The safety system engager 130 is configured to distribute remote connected vehicle operation requests from the connected vehicles as described herein. More specifically, the safety system engager 130 is configured to distribute requests at least among the remote operator devices 141. The safety system engager 130 may be further configured to distribute at least a portion of the requests to the responder devices (RDs) 150. As described herein, the requests are distributed so as to optimize servicing of those requests. To this end, the safety system engager 130 may be configured to queue the requests, to classify the requests, to classify network connectivity, combinations thereof, and other parts of processes as described herein.

Each of the remote operator devices 141 is a device operated by a remote operator who will be handling remote connected vehicle operation requests. More specifically, such remote operators perform remote driving assistance activities (e.g., remote driving or remote assistance activities as discussed above) based on requests received from the connected vehicles 110. To this end, each of the remote operator devices 141 is, includes, or is communicatively connected to a respective remote operator station (not shown) having one or more input/output devices adapted to accept inputs from the remote operator using the station and to transmit data based on those inputs to be used for controlling the connected vehicle 110 which sent the request for remote driving assistance. Such input/output devices may include, but are not limited to, mice, keyboards, input/output controllers (e.g., video game controllers), steering wheels, pedals (e.g., gas and brake pedals), sticks, combinations thereof, portions thereof, and the like.

In some implementations, the remote operator devices 141 are deployed in a cloud environment 140. Alternatively, in another implementation (not shown), one or more servers configured to forward requests to the remote operator devices 141 may be deployed in the cloud environment 140 and receive requests to be forwarded to the remote operator devices 141 from the safety system engager 130.

The responder devices 150 are devices operated by respective emergency responders. In accordance with at least some disclosed embodiments, at least a portion of remote connected vehicle operation requests distributed by the safety system engager 130 are distributed to responder devices among the responder devices 150 as part of one or more parallel flows, either instead of being distributed to one of the remote operator devices 141 or in addition to being distributed to one of the remote operator devices 141. As a non-limiting example, when image data accompanying a remote driving assistance request shows that a crash is imminent such that remote driving assistance may not be sufficient to avoid the crash. In such an example, either the request may be distributed only to one of the responder devices 150 (i.e., so that no attempt at remote driving assistance is made since the crash will likely have occurred before the request is received by one of the remote operator devices 141) or the request is distributed to one of the responder devices 150 in parallel to another instance of the request being distributed to one of the remote operator devices 141 (i.e., so that the remote operator of the remote operator device 141 is provided the request and can attempt to minimize harm while the request is simultaneously being provided to a responder of the responder device 150).

The safety system engager 130 may communicate with other respective systems among the network diagram 100A via respective application programming interfaces (APIs) such as, but not limited to, an FMS-engager APIR 125, an operator-engager API 145, and a responder-engager API 155. Each API is a software interface facilitating communications between the respective systems that use the API to communicate. The APIs 125, 145, and 155 may enable or otherwise facilitate communications between and among the safety system 130 and other systems.

Additionally, data related to the APIs 125, 145, 155, or a combination thereof, may be logged, and those logs may be utilized to derive additional data for use in accordance with various disclosed embodiments. Such data may include API calls, entities that made API calls, time between API calls, and the like.

The network diagram 100B illustrates a second implementation in which the FMS 120 is deployed out of line of the connected vehicles 110 and the safety system engager 130. Such a deployment may be useful, for example, when integrating with existing channels rather than establishing a new channel for the FMS 120. Also, such an implementation may be useful for meeting certain regulatory or other requirements related to the transmission, storage, or processing of data. For example, components may be deployed in different geographical locations subject to different legal or regulatory requirements, and their respective functions may be performed in order to comply with the applicable requirements for their respective geographical locations.

In the implementations shown in FIGS. 1A-B, the safety system engager 130 is depicted as a central node. That is, in various embodiments, the safety system engager 130 or other system which performs request distribution as described herein is deployed between the connected vehicles requesting assistance and remote operators providing assistance. Such a central deployment may provide various advantages.

One such advantage of a central deployment is allowing for safety-critical management of remote operators and connected vehicles such that failure or loss of connection to a given remote operator device 141, will not lead to failure of servicing the request, as requests can be reassigned or otherwise coordinated accordingly.

Another advantage of a central deployment is the ability to audit every decision made by the central system (e.g., decisions on distributing requests) to allow for documenting and tracing all requests through the system. As a non-limiting example, data used to determine the distribution may be documented so that it can later be reviewed why a request was sent to a particular remote operator or why certain actions were taken pursuant to the request. Moreover, the central system may measure metrics related to performance of request servicing such as declinations of requests by remote operators, time for requests to be received by remote operators, time for requests to be serviced, and the like. Such metrics may be utilized to further improve request distribution determinations. As noted above, APIs used by the safety system engager 130 or other central system in order to communicate with other systems may facilitate logging allowing for such documentation.

Further, a timeline of requests and responses may be documented. The documentation may further be utilized to generate statistics or other information to be provided, for example to supervisors of remote operators, in order to make decisions related to availability of operators or operator stations (e.g., ensuring that sufficient amounts of operators and operator stations having certain capabilities are available depending on flows at different times of day and/or on different days). As another example, the information may include feedback to either a driver of a connected vehicle (or other person who initiated the request) or a manager or supervisor of remote operators. Such feedback may include, but is not limited to, a status of the request (e.g., being routed, with a remote operator, etc.) queue-based feedback (e.g., a number of times a request has automatically been reassigned, which may be utilized to determine if manual intervention and reassignment is appropriate), and the like.

A further advantage related to documenting data sent to or from the central system is using documentation (e.g., audit logs) in order to implement policies defined with respect to potential flows of requests, responses, and other data which may be identified within the documentation. Such policies may be utilized to improve servicing of requests, for example by using such policies in order to make load balancing decisions, thereby optimizing sending of requests.

It should be noted that some of the various components shown in FIGS. 1A-B are not depicted as communicating via networks merely for simplicity purposes, but that the disclosed embodiments are not limited as such. Any or all of the components may communicate via networks without departing from the scope of the disclosure. Moreover, although not depicted in FIGS. 1A-B, any or all of the components (such as the CVs 110, the FMS 120, the engager 130, the RODs 141, or the RDs 150) may be deployed in cloud environments, and may further be deployed in respective cloud environments, without departing from the scope of the disclosure.

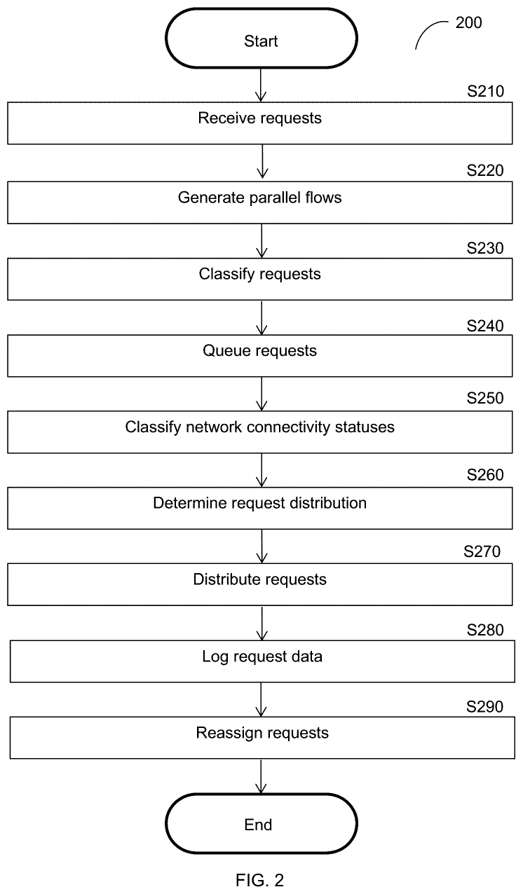

FIG. 2 is a flowchart 200 illustrating a method for distributing remote connected vehicle operation requests according to an embodiment. In an embodiment, the method is performed by the safety system engager 130, FIG. 1.

At S210, requests for remote driving assistance to be distributed are received. The requests are received from connected vehicles equipped with remote driving functionality such that the requests may be sent to remote operators (i.e., operators which are remote to the connected vehicles) in order to allow the remote operators to at least partially control respective connected vehicles. Each connected vehicle is a vehicle configured to communicate with one or more systems outside of the connected vehicle. The remote connected vehicle operation requests may include, but are not limited to, requests for remote assistance, requests for remote driving, both, and other requests to be serviced by remote operators for operation activities in driving or otherwise operating respective connected vehicles for which the requests were sent (e.g., the connected vehicles 110, FIGS. 1A-B).

At S220, parallel flows are generated for at least some of the requests. In an embodiment, parallel flows are generated when one or more parallel flow triggers are detected. To this end, in an embodiment, S220 includes applying one or more parallel flow trigger rules defining triggers for generating parallel flows. The parallel flow trigger rules may define triggers for generating parallel flows with respect to factors such as, but not limited to, emergencies (e.g., as indicated by predetermined emergency indicators included in requests), sensitive actions (e.g., certain predetermined actions which are time-sensitive or otherwise for which parallel flows are to be utilized to ensure that they are completed appropriately), training or qualification (e.g., such that parallel flows are generated for requests requiring certain training, experience or qualification criteria), combinations thereof, and the like.

In an embodiment, the parallel flows are generated based on emergency indicators included among the requests. In such an embodiment, certain requests are determined to be high urgency based on their emergency indicators. In a further embodiment, urgency determination rules may be applied based on emergency indicators among the requests in order to determine an urgency of each request. Such urgencies may be, for example but not limited to, relative urgencies (e.g., defined as high, low, etc.), absolute urgencies (e.g., having numerical values indicating a degree of urgency such as a number from 1 to 10), and the like. The urgency determination rules may define criteria with respect to potential emergency indicators that individually or in combination correspond to high urgency requests.

In an embodiment, the parallel flows include instances of the requests which are high urgency, and may include the high urgency requests or duplicate instances of those high urgency requests. To this end, in a further embodiment, S220 also includes generating such duplicate instances of the high urgency requests. The duplicate instances of the high urgency requests may be distributed to, for example, devices of emergency responders (e.g., the responder devices 150, FIGS. 1A-B) in parallel to other instances of the high urgency requests being distributed to remote operators (e.g., remote operators using the remote operator devices 141, FIGS. 1A-B). Alternatively, the high urgency requests may be sent only to responder devices and not to remote operator devices.

In an embodiment, the parallel flows are generated such that at least some of the flows are directed through a central system or other system managing request distribution (e.g., the safety system engager 130, FIG. 1) and one or more parallel flows for those flows (i.e., parallel flows that include duplicate instances of data in the original flows) are directed through an external system such as, but not limited to, an emergency services responder system (e.g., a system that manages the responder devices 150, FIG. 1), a fleet management system (e.g., the fleet management system 120, FIG. 1), both, and the like. In other words, when the requests are distributed by transmitting the requests via a first system (e.g., the engager 130), at least a portion of the parallel flows may be distributed by transmitting that portion of the parallel via a second system (e.g., the fleet management system 120).

At S230, the requests are classified. In an embodiment, the requests are classified into classifications corresponding to capabilities, conditions, or both, which are required to effectively service the request (i.e., for a remote operator to provide suitable assistance). The request classifications may be utilized to distributed requests as described herein, for example, by determining distributions such that requests are distributed to operators having the capabilities or deployed under conditions that allow for adequately servicing the requests.

Such classifications may be predetermined classifications defined based on factors such as, but not limited to, operator capabilities (i.e., capabilities, authorizations, or both, which may be possessed by a remote operator), station capabilities (i.e., functional capabilities which may be possessed by a station of a remote operator), network connectivity (i.e., based on network conditions which may affect the transmission or receipt of request data), combinations thereof, and the like. As a non-limiting example, a request for remote driving may be classified into a classification requiring station capabilities including vehicle control input devices (such as a steering wheel and pedals) as well as operator capabilities including authorization to perform remote driving activities.

The requests may be classified based on data included in the requests which indicate potential requirements for each request such as, but not limited to, a type of request (e.g., remote driving or remote assistance), specific actions or activities that are requested (e.g., control of steering, control of gas and braking, navigation assistance, phone assistance, combinations thereof, etc.), content included in the request (e.g., whether the request includes image or video content in addition to or instead of textual content), amount of content to be transmitted pursuant to the request (e.g., an amount of image or video data which will be transmitted by a connected vehicle, for example as measured with respect to a number of cameras of the connected vehicle which will be transmitting data), combinations thereof, and the like.

As noted above, in some embodiments, the requests are further classified based on network connectivity. As a non-limiting example, requests including image or video data and a type of request asking for remote driving, may be classified into a classification requiring better network conditions than a request which only includes textual data with a type of request asking for remote assistance with navigation because such an image-based remote driving request will require better network connectivity for the remote operator to successfully control and navigate the connected vehicle as compared to the navigation assistance request which may not require the same real-time responsiveness and control.

Further, the network connectivity may be determined based on network performance measurements (e.g., latency) which are measured based on actual network performance, based on geographic location (e.g., certain geographic locations known to have particular conditions such as high latency, low reception or congestion), both, and the like.

In another embodiment, the requests may be further classified based on one or more external factors which are unrelated to the connected vehicle or transmitting data to the connected vehicle. Such external factors may include environmental factors such as, but not limited to, weather, traffic, and the like. Moreover, in a further embodiment, S230 may include analyzing data included with the requests to determine such external factors. As a non-limiting example, images included in the request may be analyzed to determine an amount of traffic surrounding the connected vehicle. As another non-limiting example, global positioning system (GPS) data included in the request representing a location of the connected vehicle may be analyzed in order to determine a geographic location of the connected vehicle, and the determined geographic location may be correlated to weather data for that geographic location in order to determine weather at a location of the connected vehicle.

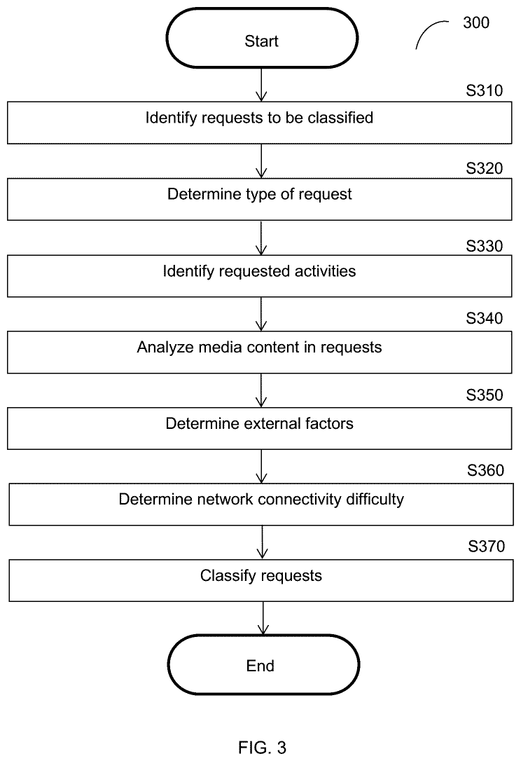

An example process for classifying requests is described further below with respect to FIG. 3.

At S240, the requests are queued. The requests may be queued based on factors such as, but not limited to, time pendency (i.e., how long each request has been pending service), user policies, urgency (e.g., determined based on emergency indicators as described above), combinations thereof, and the like. To this end, in an embodiment, S250 includes applying one or more queueing rules in order to determine a queue order for the requests. The requests may be organized into one or more queues. For example, all requests may be organized into one queue, or requests may be grouped and organized into queues corresponding to respective groups of requests.

In some embodiments, the queue may be manually adjusted. In this regard, it is noted that additional circumstances not reflected in the queueing rules may affect which requests should be serviced first. As a non-limiting example, if a manual operator is aware of certain events occurring in the real world which may make navigation more treacherous for certain connected vehicles, the manual operator may adjust an initial queue in order to prioritize requests for remote driving assistance to those connected vehicles.

At optional S250, network connectivity statuses are classified for remote operator devices, connected vehicles, or both. In an embodiment, the network connectivity classifications are defined at least with respect to one or more metrics related to transmission quality such as, but not limited to, signal quality, error rate, packet loss, latency, jitter, combinations thereof, and the like. As discussed further below, the network connectivity status classifications may be utilized when determining distributions of requests, for example, in order to distribute requests to remote operator devices having network connectivity which would allow for effectively servicing those requests.

At S260, a distribution for the requests is determined. In an embodiment, the distribution is determined based at least on the classifications of the requests. In a further embodiment, the distributed is also determined based on capabilities associated with potential remote operators such as, but not limited to, capabilities of the remote operators, capabilities of operator workstations accessible to the remote operators, both, and the like. The distribution includes assignments of the requests to respective remote operators such that, when the requests are transmitted as discussed below, the requests are sent to the respective remote operators to which they are distributed. Alternatively or in combination, the distribution may be determined based further on the queue. As a non-limiting example, requests which are higher in the queue may be assigned to remote operators who are more responsive than requests of the same classification which are lower in the queue in order to service the higher queued requests faster.

In yet a further embodiment, the distribution is determined based further on network connectivity status classifications, for example the classifications determined at S250. More specifically, for a classification of each request, a remote operator to which the request should be distributed may be determined based further on network connectivity of one or more systems (e.g., a remote operator device, a system which forwards requests to destination remote operator devices among a group, both, etc.) in order to filter out or otherwise avoid remote operators for which network connectivity may present an obstacle to successfully receiving data, transmitting data, or otherwise performing activities using network connections which may be necessary to service a given request.

To this end, S260 may include applying rules for determining acceptable measurements of network connectivity for certain request classifications. As a non-limiting example, for a request classification indicating that the request is a request for remote driving based on video to be received at the remote operator device, only remote operators using remote operator devices having a latency below a threshold value may be selected from when determining distributions in order to ensure that high latency connections do not interfere with the requested remote driving.

At S270, the requests are distributed based on the distribution. In an embodiment, distributing the requests further includes transmitting the requests. At least some of the requests are transmitted to remote operator devices of respective remote operators (e.g., devices among the remote operator devices 141, FIGS. 1A-B). In a further embodiment, additional data may be added to the requests or otherwise transmitted with the requests. Such additional data may include, but is not limited to, metadata indicating the classifications of the requests, data indicating the destination for the request (e.g., based on an identity of a remote operator to which the request is to be distributed), an operator station to be used for servicing the request, combinations thereof, and the like.

At optional S280, data related to the distributed requests is logged. The logged data may include data of the requests, data of responses to the requests, data generated by analyzing the requests and responses, data related to API usage (e.g., logs of API calls) pursuant to the requests and responses, combinations thereof, portions thereof, and the like. As noted above, APIs may be utilized both to facilitate communications between a central system and various other systems as well as to provide data which can be logged. Accordingly, in embodiments in which API activity is logged at S280, the APIs are leveraged in order to provide additional data which may be logged and subsequently utilized.

At optional S290, the requests may be reassigned. Each request may be reassigned automatically (e.g., based on certain predetermined criteria), or may be assigned manually (e.g., based on inputs from a manager of remote operators). When requests are reassigned automatically, S290 may include applying reassignment rules based on data related to the requests. As a non-limiting example, such reassignment rules may be defined so as to reassign requests that have not yet been serviced (e.g., by a remote operator assuming remote driving assistance activities) within a threshold period of time since being distributed to a remote operator device. As another non-limiting example, such reassignment rules may be defined so as to reassign requests that have been denied by a remote operator at least a threshold number of times. As a further non-limiting example, when requests to a particular remote operator have been denied above a threshold number of times in a certain period of time (e.g., more than 5 times within 24 hours), then subsequent requests to that remote operator may be reassigned to other operators, at least temporarily (e.g., for the next 12 hours).

It should be noted that step S290 is depicted in FIG. 2 as occurring after step S280 (i.e., such that the requests are reassigned after they are distributed), but that in at least some implementations, the requests may be reassigned prior to distribution or requests may be reassigned both before and after distribution. As a non-limiting example, the distribution may be presented to a remote driving assistance operator manager as a proposed distribution, and the remote driving assistance operator manager may select any or all of the allotted distributions for the requests to be redistributed along with reassignments of new operators to which the redistributed requests are to be transmitted.

FIG. 3 is a flowchart 300 illustrating a method for classifying requests according to an embodiment. In an embodiment, the method is performed by the safety system engager 130, FIG. 1.

At S310, requests to be classified are identified. The requests may include, for example, the requests received at S210, FIG. 2.

At S320, a type of each request is determined. In an embodiment, the determined types include remote driving and remote assistance. In some embodiments, multiple types may be determined for a given request. As a non-limiting example, a request that asks for both remote driving and remote assistance may be determined as both types. The type of each request may be explicitly indicated in each request or may be determined, for example, based on an analysis of content in the request indicating the kind of operation activities which are needed. As a non-limiting example, textual or audio content included in the request may be analyzed using natural language processing in order to determine words communicated by a driver of a connected vehicle, and those words may be analyzed to determine a type of request.

At S330, activities being requested according to each request are identified. The activities may include, but are not limited to, selecting a path, providing navigation instructions, drawing a navigation path, inputting a destination into a global positioning system (GPS) of the connected vehicle, directly controlling vehicle operations (e.g., steering, acceleration, braking, etc.), combinations thereof, and the like. The activities may be explicitly included in the request, may be determined based on the type of request, and the like.

At S340, media content among the requests is analyzed. For example, images, video, or both, may be visually analyzed in order to identify potential obstacles, conditions (e.g., weather or traffic conditions), and other factors which may affect teleoperation or otherwise servicing of the request.

At S350, one or more external factors may be determined. The external factors include factors which are not explicitly indicated in the response and which may affect vehicle navigation or otherwise affect servicing of the request. Such external factors may be utilized to classify requests in a manner that helps making decisions related to network connectivity. More specifically, the external factors may be used to further distinguish among levels of network connectivity for requests (e.g., a request for remote driving including images showing more obstacles will have a higher level of difficulty for navigating and, consequently, a higher network connectivity difficulty, than an otherwise similar request including images showing a lower number of obstacles). For example, if there are several obstacles in the vicinity of a vehicle which sent a remote driving request, it may be safety critical to have a threshold level of network connectivity in order to service the request.

In some embodiments, some or all of the external factors may be determined based on the analysis of the media content. As a non-limiting example, if certain weather or traffic conditions are identified based on analysis of the media content, those weather or traffic conditions may be included among the external factors.

At S360, a network connectivity difficulty for each request is determined. The network connectivity difficulty may be expressed as a relative value (e.g., belonging to one of the classes high, medium, or low) or an absolute value (e.g., a number from 1 to 10). The network connectivity difficulty represents a degree of challenge posed by the request, for example, how difficult certain activities of the request will be such that more difficult requests will require better network connectivity to be effectively services than less difficult requests.

As discussed above, network connectivity of operator stations may be classified, and those network connectivity classifications may be utilized to match requests having certain levels of network connectivity difficulty with operators capable of effectively servicing those requests. This improves successfulness of servicing requests, and may further optimize use of network resources by routing requests to operators who are more likely to service those requests without requiring reassignment and redistribution.

At S370, the requests are classified. In an embodiment, the requests are classified into predetermined classifications defined with respect to the results of any or all of steps S320 through S360.

As noted above, APIs may be utilized to receive the requests. The APIs may help facilitate communicating the requests in a unified or otherwise common format even when requests come from connected vehicles using software developed by different entities. In turn, this common formatting may allow for more readily classifying requests, i.e., because any request classification rules may be applied to data in this common format. Consequently, classifications may be determined more accurately when using APIs to communicate data from different connected vehicles, particularly when those APIs all provide data in the same common format to the system distributing the requests.

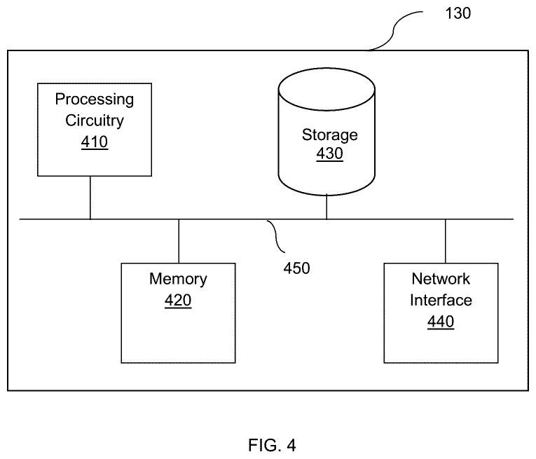

FIG. 4 is an example schematic diagram of a safety system engager 130 according to an embodiment. The safety system engager 130 includes a processing circuitry 410 coupled to a memory 420, a storage 430, and a network interface 440. In an embodiment, the components of the safety system engager 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the safety system engager 130 to communicate with, for example, the connected vehicles 110, the fleet management system 120, the remote operator devices 141, the responder devices 150, combinations thereof, and the like.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for contextual distribution of remote connected vehicle operation requests, comprising:
classifying a plurality of requests for remote connected vehicle operation into a plurality of classifications, wherein each request corresponds to a respective connected vehicle of a plurality of connected vehicles;
determining a distribution for the plurality of requests based on the plurality of classifications, wherein at least a portion of the plurality of requests is assigned to respective operators of a plurality of operators based on capabilities associated with each of the plurality of operators; and
transmitting the plurality of requests based on the distribution.

2. The method of claim 1, further comprising:
creating at least one queue of the plurality of requests based on the plurality of classifications, where the distribution is determined based further on the at least one queue.

3. The method of claim 1, wherein the method is performed by a central system, further comprising:
translating each of the plurality of requests into a plurality of translated requests based on criteria defined in at least one request distribution policy via an application programming interface disposed between each of the plurality of vehicles and the central system, wherein the distribution is determined based further on the plurality of translated requests.

4. The method of claim 1, further comprising:
generating at least one parallel flow for the plurality of requests based on at least one parallel flow trigger, wherein the distribution is determined based further on the at least one parallel flow.

5. The method of claim 1, wherein the plurality of requests is transmitted via a first system, wherein at least a portion of the at least one parallel flow is transmitted via a second system.

6. The method of claim 1, wherein at least one first request of the plurality of requests is assigned to at least two operators of the plurality of operators.

7. The method of claim 1, further comprising:
generating at least one additional instance for each of the at least one first request, wherein the distribution is determined based further on the at least one additional instance generated for each of the at least one first request.

8. The method of claim 1, further comprising:
classifying a plurality of network connectivity statuses into a plurality of network connectivity status classifications, each network connectivity status being associated with a respective remote operator of the plurality of remote operators, wherein the distribution is determined based further on the plurality of network connectivity status classifications.

9. The method of claim 1, wherein the capabilities associated with the plurality of operators include at least one operating station capability of each of a plurality of operating stations accessible to the plurality of operators.

10. The method of claim 1, wherein at least a portion of the requests is assigned to automated remote vehicle operation systems.

11. A non-transitory computer readable medium having stored thereon instructions for causing a processing circuitry to execute a process, the process comprising:
classifying a plurality of requests for remote connected vehicle operation into a plurality of classifications, wherein each request corresponds to a respective connected vehicle of a plurality of connected vehicles;
determining a distribution for the plurality of requests based on the plurality of classifications, wherein at least a portion of the plurality of requests is assigned to respective operators of a plurality of operators based on capabilities associated with each of the plurality of operators; and
transmitting the plurality of requests based on the distribution.

12. A system for contextual distribution of remote driving and remote assistance requests, comprising:
a processing circuitry; and
a memory, the memory containing instructions that, when executed by the processing circuitry, configure the system to:
classify a plurality of requests for remote connected vehicle operation into a plurality of classifications, wherein each request corresponds to a respective connected vehicle of a plurality of connected vehicles;
determine a distribution for the plurality of requests based on the plurality of classifications, wherein at least a portion of the plurality of requests is assigned to respective operators of a plurality of operators based on capabilities associated with each of the plurality of operators; and
transmit the plurality of requests based on the distribution.

13. The system of claim 12, wherein the system is further configured to:
create at least one queue of the plurality of requests based on the plurality of classifications, where the distribution is determined based further on the at least one queue.

14. The system of claim 12, wherein the system is further configured to:
translate each of the plurality of requests into a plurality of translated requests based on criteria defined in at least one request distribution policy via an application programming interface disposed between each of the plurality of vehicles and the system, wherein the distribution is determined based further on the plurality of translated requests.

15. The system of claim 12, wherein the system is further configured to:
generate at least one parallel flow for the plurality of requests based on at least one parallel flow trigger, wherein the distribution is determined based further on the at least one parallel flow.

16. The system of claim 12, wherein the plurality of requests is transmitted via a first system, wherein at least a portion of the at least one parallel flow is transmitted via a second system.

17. The system of claim 12, wherein at least one first request of the plurality of requests is assigned to at least two operators of the plurality of operators.

18. The system of claim 12, wherein the system is further configured to:
generate at least one additional instance for each of the at least one first request, wherein the distribution is determined based further on the at least one additional instance generated for each of the at least one first request.

19. The system of claim 12, wherein the system is further configured to:
classify a plurality of network connectivity statuses into a plurality of network connectivity status classifications, each network connectivity status being associated with a respective remote operator of the plurality of remote operators, wherein the distribution is determined based further on the plurality of network connectivity status classifications.

20. The system of claim 12, wherein the capabilities associated with the plurality of operators include at least one operating station capability of each of a plurality of operating stations accessible to the plurality of operators.

21. The system of claim 12, wherein at least a portion of the requests is assigned to automated remote vehicle operation systems.
